(19) United States
(12) Patent Application Publication
(10) Pub. No.: US 2025/0303497 A1
(43) Pub. Date: Oct. 2, 2025

(54) LASER MACHINING SYSTEM FOR MACHINING A WORKPIECE BY MEANS OF AN OUTPUT LASER BEAM

(71) Applicant: TRUMPF LASER AG, Schramberg (DE)

(72) Inventors: Malte Kumkar, Weimar (DE); Julian Hellstern, Rottweil (DE)

(21) Appl. No.: 19/235,629

(22) Filed: Jun. 12, 2025

Related U.S. Application Data
(63) Continuation of application No. PCT/EP2023/085544, filed on Dec. 13, 2023.

(30) Foreign Application Priority Data
Dec. 13, 2022 (DE) 10 2022 133 073.7

(51) Int. Cl. B23K 26/082; B23K 26/064; B23K 26/38

(52) U.S. Cl. CPC B23K 26/082; B23K 26/064; B23K 26/38

(57) ABSTRACT

A laser machining system includes a laser radiation source for generating an input laser beam, and an optical arrangement for converting the input laser beam into an output laser beam for machining a workpiece. The optical arrangement includes a long-axis focusing optical unit for focusing a beam path along a long axis, a long-axis scanner for scanning the beam path with a long-axis scan direction component, a short-axis focusing optical unit for focusing the beam path along a short axis, and a short-axis scanner for scanning the beam path with at least one short-axis scan direction component. The laser machining system further includes an advancement device for advancing the workpiece relative to the optical arrangement, and a control device configured to synchronize the scanning of the beam path along the long-axis scan direction component with the scanning of the beam path along the short-axis scan direction component.

### CROSS REFERENCE TO RELATED APPLICATIONS

This application is a continuation of International Application No. PCT/EP2023/085544 (WO 2024/126565 A1), filed on Dec. 13, 2023, and claims benefit to German Patent Application No. DE 10 2022 133 073.7, filed on Dec. 13, 2022. The aforementioned applications are hereby incorporated by reference herein.

### FIELD

Embodiments of the present invention relate to a laser machining system for machining a workpiece by means of an output laser beam, which comprises an advancement device for advancing the workpiece relative to an optical arrangement of the laser machining system.

### BACKGROUND

Such a laser machining system is known, for example, from DE3711905A1. In the laser machining system therein, an optical arrangement with a polygon wheel is used to carry out laser machining of a material web moving relative to the optical arrangement.

With such laser machining systems from the prior art, the relative movement of the material web relative to the optical arrangement can be compensated for by moving the polygon wheel accordingly.

### SUMMARY

Embodiments of the present invention provide a laser machining system for machining a workpiece by using an output laser beam. The laser machining system includes a laser radiation source for generating an input laser beam, and an optical arrangement for converting the input laser beam into an output laser beam for machining the workpiece. The output laser beam propagates in a propagation direction and has a beam cross-section in a working region that extends along a long axis of the optical arrangement. The optical arrangement includes a long-axis focusing optical unit for focusing a beam path within the optical arrangement between the input laser beam and the output laser beam along the long axis, a long-axis scanner for scanning the beam path with at least one long-axis scan direction component along the long axis, a short-axis focusing optical unit for focusing the beam path along a short axis, and a short-axis scanner for scanning the beam path with at least one short-axis scan direction component along the short axis. The laser machining system further includes an advancement device for advancing the workpiece relative to the optical arrangement in an advancement direction, and a control device configured to synchronize the scanning of the beam path along the at least one long-axis scan direction component with the scanning of the beam path along the at least one short-axis scan direction component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic outline of an optical arrangement for the laser machining system of FIG. 5 according to a first exemplary embodiment, divided into the influencing of the beam path along a short axis and a long axis of a generated linear output laser beam;

FIG. 2 shows a schematic outline for illustrating the beam path in the optical arrangement of FIG. 1 according to some embodiments;

FIG. 3 shows a schematic outline of an optical arrangement according to a second exemplary embodiment;

FIG. 4 shows a schematic outline for illustrating the beam path along the long axis in the optical arrangement of FIG. 1 according to some embodiments;

FIG. 5 shows a schematic view of a laser machining system according to an exemplary embodiment, comprising one of the optical arrangements of FIG. 1 or 3;

FIGS. 6 and 7 show schematic outlines of exemplary embodiments for laser machining with the laser machining system of FIG. 5;

FIGS. 8-12 show schematic outlines of an exemplary embodiment of pulsed laser machining with the laser machining system of FIG. 5; and

FIGS. 13-24 show schematic outlines of an exemplary embodiment of multi-spot profile laser machining with the laser machining system of FIG. 5.

### DETAILED DESCRIPTION

Embodiments of the invention provide an improved laser machining system for machining a workpiece that is moved relative to its optical arrangement, which laser machining system is in particular more flexible and provides better machining quality.

According to some embodiments, a laser machining system for machining a workpiece by means of an output laser beam is proposed, the laser machining system having a laser radiation source for generating an input laser beam. Furthermore, the laser machining system has an optical arrangement for converting the input laser beam into an output laser beam for machining the workpiece, which output laser beam propagates in a propagation direction and which has a beam cross-section extending along a long axis of the optical arrangement in a working region, the optical arrangement having: a long-axis focusing optical unit for focusing a beam path within the optical arrangement between the input laser beam and the output laser beam along the long axis, a long-axis scanner component for scanning the beam path with at least a long-axis scan direction component along the long axis, a short-axis focusing optical unit for focusing the beam path along a short axis of the optical arrangement extending perpendicular to the long axis, optionally a short-axis beam-shaping optical unit for beam shaping of the beam path along the short axis, and a short-axis scanner component for scanning the beam path at least with a short-axis scan direction component along the short axis. Furthermore, the laser machining system has an advancement device for advancing the workpiece relative to the optical arrangement in an advancement direction and a control device for synchronizing the scanning of the beam path along the long-axis scan direction component with the scanning of the beam path along the short-axis scan direction component.

In particular, the synchronization by means of the control device can be configured to compensate for a relative movement, resulting from the advancement of the workpiece in the advancement direction between the workpiece and the optical arrangement by scanning the beam path with the short-axis scanner component.

According to embodiments of the invention, a solution is thus provided in which separate scanner components are provided for the short axis and the long axis, but which are synchronized with each other in their scanning movement, in particular in such a way that the compensation for the relative movement between the workpiece and the optical arrangement can be carried out flexibly by means of corresponding control instructions of the control device to the short-axis scanner component, wherein the scanning with the long-axis scan direction component is not substantially influenced by this. In particular, compensation can be carried out solely by short-axis scanning with the short-axis scan direction components so that short-axis scanning is also used solely for compensating for the relative movement. In addition to the flexible responsiveness of the laser machining system according to embodiments of the invention, a better imaging of the beam cross-section or beam profile can be achieved according to embodiments of the invention, which in turn improves the machining and thus improves the overall quality of the laser-machined workpiece.

In particular, a beam profile with a preferred direction can be used, which is positioned in particular precisely in relation to the workpiece and aligned with a preferred machining direction in relation to the workpiece. For continued machining on the workpiece along a line, in particular a preferred machining line, the optical arrangement and the long-axis scan direction component are aligned, in particular so as to match the long axis, preferably parallel to the preferred machining line of the workpiece. If the relative movement between the optical arrangement and the workpiece now deviates from the long-axis direction during laser machining, this can be advantageously compensated for by a particularly superimposed short-axis scanning movement in the short-axis scan direction component, in particular so as to match the short axis, wherein this short-axis scanning movement can preferably be set independently of the long-axis scanning movement, as is explained in more detail below. Preferably, the short-axis scanner component is positioned in a corresponding short-axis far-field region and separated from the long-axis scanner component in the beam propagation direction.

The short axis and the long axis of the optical arrangement and thus of its optical units are in particular perpendicular to each other. With the proposed astigmatic optical arrangement, the beam cross-section can change both in size and shape during propagation. In the working region on the workpiece, the output laser beam can have an elliptical beam profile, in particular with an aspect ratio of short axis to long axis of, for example, at least 1:3, in particular at least 1:5 and furthermore in particular 1:10, so that a linear beam cross-section extending along the long axis LA is observed. In particular, a linear optical unit extending in the long-axis spatial direction can be used for focusing in the short-axis spatial direction.

Components such as optical units, (spatial) directions, regions or other information are appended with “KA” for short axis or with “LA” for long axis in order to indicate their correlation with the respective axes, for example the optical effect of an optical unit on the short axis or long axis, and thus create a distinction between the short axis and the long axis. Preferably, the components are aligned with their preferred directions in the short-axis or long-axis spatial direction. The beam cross-section, also referred to as the beam profile, in particular with regard to its greatest extent, typically extends in the long-axis spatial direction, very particularly at least in the broadest sense linearly, and, depending on the configuration, other extents are also conceivable in which the beam cross-section extends in terms of its length in a direction different from the long-axis spatial direction. The beam path in this case refers to the laser beam within the optical arrangement, i.e. between the input on the optical arrangement, where it is referred to as the input laser beam, and the output on the optical arrangement, where it is referred to as the output laser beam. A far-field region of the beam path can be located within the optical arrangement, while a near-field region of the beam path or the output laser beam, on the other hand, is linked to the working region and is located in particular in or on the workpiece in the working region.

The long-axis focusing optical unit and/or the short-axis focusing optical unit are preferably designed as an astigmatic/anamorphic optical component or group of components, possibly as a cylindrical optical unit, i.e. their optical functionality is restricted to the long-axis spatial direction or short-axis spatial direction. The long-axis and short-axis scanner components can, for example, each be a mirror scanner with galvanometer drive and/or a rotating polygon mirror scanner.

The advancement device can, for example, be a conveyor belt or a rotating deflection roller, on which an in particular continuous workpiece or a workpiece web is provided in front of the optical arrangement. A workpiece web as a workpiece can be machined, for example cut into pieces, accordingly by the output laser beam.

The control device can be a cross-component control device of the laser machining system or can be provided in one or more components of the laser machining system, for example as part of the optical arrangement, in particular the short-axis scanner component.

Although reference is made here to one input laser beam and one output laser beam, it is conceivable and possible for the optical arrangement to generate a plurality of output laser beams or partial beams (from one or a plurality of input laser beams) that are parallel or move in parallel in the working region, in particular in the short-axis spatial direction. The output laser beams or partial beams can be offset in the working region in terms of location and/or angle. This can be realized by partial beam profiles separated in the short-axis spatial direction in the working region or by means of the multiple beam interference of overlapping partial beam profiles with a short-axis angular offset in the working region. The use of partial beams allows an increase in the width of the output laser beam or parallel line machining when there is an offset in the short-axis spatial direction. For example, this type of parallel line machining can be used for the dicing of electronic chips, multi-line engraving of electrical steel sheets, descaling of metal surfaces or structuring of battery foils.

In particular, the long-axis scanner component and the short-axis scanner component can be scanner components that function independently of each other. This functional independence of the scanner components from each other, which can be separate components or not functionally dependent on each other, provides maximum flexibility for positioning the output beam in the machining region and in particular for compensating for the relative movement between the workpiece and the optical arrangement resulting from the advancement of the workpiece.

Furthermore, in particular the long-axis scanner component can be configured for scanning the beam path or output laser beam in a preferred machining direction parallel to the long axis, in particular a preferred line direction, in such a way that there is a first angle α>0° between a long-axis scan direction or preferred machining direction and the advancement direction. In particular, the first angle α can be 0°<α<180°, for example α=90°. The preferred machining direction of the beam profile can be oriented in particular in the long-axis direction and/or short-axis direction.

More particularly, the first angle α can be >90°. In the case of such a deviation of the preferred machining direction from an orthogonal to the advancement direction, a long-axis scan direction with a partial compensation for the relative movement is set to reduce the required scan field, the required scanning speed, etc.

In addition, the long-axis scanner component can be configured for at least an average long-axis scanning speed v_{LA}=B_{b}/(tₛ·sin(α))+v_{R}·cos(α) and/or the short-axis scanner component can be configured at least for an average short-axis scanning speed (in the coordinate system of the arrangement) v_{KA}=vᵣ·sin(α), wherein B_{b} is a machining width on the workpiece perpendicular to the advancement direction, tₛ is a machining time for the machining length B₁=B_{b}/sin(α) (from machining start to machining end of the machining length during a scanning operation) and v_{R} is the advancement speed in the advancement direction. The effective scanning speed is related to the relative movement between the laser beam and the workpiece, so it can also be referred to as a machining speed. With such a design, it is possible to achieve rectilinearly continued machining on the workpiece, in particular a minimum line width and/or edge steepness of the effective beam cross-section (while maintaining the other parameters). Substantially the effective long-axis scanning speed is relevant for the machining effect, while the short-axis scanning speed is used in particular solely to compensate for the relative movement. The quotient of machining width and machining time B_{b}/tₛ can be interpreted as the (average) machining speed v_{B}=B_{b}/t_{S}=Bₗ·sin(α)/tₛ perpendicular to the advancement direction. The advancement B_{S} of the workpiece over the machining time tₛ represents the minimum period of the machining operations in the advancement direction (assuming that a plurality of partial beams are not used simultaneously and that the dead time of the system is 0%, i.e. the start of the next machining operation is instantaneous after the end of the preceding machining operation).

In particular, it is possible for the long-axis scanner component to be configured for a long-axis scan field length s_{LA}≥B_{b}/sin(α)+Bₛ·cos(α) and/or for the short-axis scanner component to be configured for a short-axis scan field width s_{KA}≥Bₛ·sin(α), wherein Bₛ is a length swept over during the scan and in particular during the machining time tₛ and wherein Bₛ is oriented in particular in the advancement direction. In this case, machining can be carried out with the optical arrangement without an offset perpendicular to the advancement direction. Otherwise, the information regarding the scanning region relates in particular to the center of the beam profile.

Furthermore, the optical arrangement can be designed in such a way that the beam cross-section is formed by a multi-spot profile. Due to the astigmatic focusing of the optical arrangement, such a multi-spot profile is stretched in a resulting line direction and thus generates the beam cross-section on the workpiece.

It can be provided that the multi-spot profile has spots distributed along the short axis and the long axis. Alternatively, it is also possible to align the spots of the multi-spot profile only along the short axis or along the long axis. The spots can also be arranged to overlap, as explained in more detail below.

In particular, it is possible for the multi-spot profile with a line direction of the beam cross-section resulting from astigmatic focusing of the optical arrangement to be set at a setting angle>0° relative to the long-axis scan direction component, which in particular corresponds to the long axis. Such a choice makes it easier to ensure the z-position tolerance by limiting the machining to one short region in the advancement direction. In a roll-to-roll application, for example, machining can also take place in a region in which the workpiece rests on a deflection roller.

In addition, it is also possible for the control device to be configured to adjust the laser power of the output laser beam to the speed of the beam movement of the output laser beam on the workpiece and/or of the scanning of the beam path. By adjusting the laser power to the workpiece-related, effective scanning speed, a typically fluctuating, now reproducible machining result can be achieved. The advantage of this is improved reproducibility with increased flexibility and tolerance.

It is also possible for the laser radiation source to be a pulsed, in particular ultrashort-pulsed, laser radiation source. A pulsed laser radiation source allows extended control of laser machining, in particular with regard to the generated heat accumulation. Typical spatial and temporal gradients of the effect to be achieved in the workpiece are relevant here. Often a threshold intensity or threshold fluence is required and intensity and fluence must be selected in suitable windows. With a CW laser radiation source, such thresholds or ranges can often not be realized or can only be realized with difficulty by selecting the appropriate power, beam shape and beam dynamics.

However, the pulsed laser radiation source has proven to be advantageous and preferable to a CW laser radiation source in the present application. It makes it possible to provide machining that can be modulated precisely in terms of position in the scan direction. An ultrashort pulsed laser radiation source in particular has advantages when there is an intensity threshold or in the case of an effect via a dynamically thermomechanically induced mechanism of action. Even in the case of high beam dynamics, it is possible to operate with positional accuracy and there is only a negligible beam movement on the workpiece over the pulse duration.

It is possible for the control device to be configured to adjust a pulse repetition frequency to the effective scanning speed of the scanning with the long-axis scanner component. This means that the laser pulse parameters, the energy per unit length and the overlap or modification distance can be maintained on the workpiece. It is also possible to adjust to a speed that varies over the scanning region, resulting in a deflection-dependent speed on the workpiece.

It is also possible for the control device to be configured for position-synchronized pulse triggering along the long axis. This means that the laser pulses are triggered on the basis of specific positions on the long axis, i.e. they are synchronized with these positions. This allows greater precision with respect to adjustment of the repetition frequency, since the position can also be controlled. In addition, the position-synchronized pulse triggering is suitable for increased dynamics, e.g. for machining even in the case of acceleration with a galvo scanner as a long-axis scanner component.

Furthermore, it is possible for the control device to be configured for position-adjusted selection of laser machining parameters along the long axis. This means that the laser machining parameters are selected according to the position on the long axis. In particular, this allows the laser machining parameters to be adjusted to deflection-dependent beam properties, such as distortion, by adjusting the pulse energy and repetition frequency, for example. This also allows adjustment to workpiece properties or machining specifications that vary in the scan direction. For example, other laser machining parameters can be used for dicing in edge coatings or at intersections of perpendicularly oriented ablation lines.

The long-axis scanner component can also carry a measuring beam path of an optical sensor system. This means that the long-axis scanner component can also be used for diagnostics at the same time; in particular, it can precede, accompany and/or follow the machining. Advantageously, a correlation with the beam path can be used for machining. Possible options include, for example, prior position detection, distance and/or depth detection (beforehand and/or afterwards), in particular for adjusting the laser machining parameters in the current or subsequent pass, process monitoring, e.g. emission, reflection, OCT, WIM, . . . , in particular concurrently, and/or e.g. detection of the process phase, for example by means of spectroscopy, e.g. the achievement of a backside coating.

It is also possible for the optical arrangement to also have a short-axis relay optical unit for imaging a short-axis far-field region of the beam path within the optical arrangement along the short axis. Such an optical arrangement thus allows an astigmatic optical concept with particularly strong focusing in the short axis (KA), which is in particular high-resolution, or short-axis spatial direction and a large working field in the long axis (LA) or long-axis spatial direction. This allows improved control of the beam distribution in an enlarged working field in the short-axis spatial direction, in particular by integrating an additional optical functionality between the scanner component, scanning at least in the long-axis spatial direction as a scan direction component, and the short-axis focusing optical unit by means of the short-axis relay optical unit and/or possibly one or a plurality of further short-axis optical units, which functionality supports influencing of the angular and/or spatial distribution in a short-axis far-field region corresponding to the working region of the output laser beam.

In particular, the relay optical unit ensures short-axis far-field imaging between the short-axis scanner component, which in particular images a short-axis far-field region, which is associated with the working region via the short-axis focusing and localized after the (long-axis) scanner component, backwards in the beam propagation direction into a region closer to the beam input into a corresponding short-axis far-field region. This corresponding short-axis far-field region is preferably located in front of the long-axis focusing and/or the long-axis scanner component. The short-axis beam distribution in the region of the corresponding short-axis far-field region is influenced in particular by the short-axis beam-shaping optical unit. The short-axis scanner component is located in particular in the region of a corresponding short-axis far-field region and preferably substantially influences the short-axis angle distribution in this region. A component of the short-axis far-field imaging or short-axis relay optical unit is preferably arranged between the short-axis focusing and the long-axis focusing and/or the long-axis scanner component. The short-axis far-field imaging preferably contains a further component, which is preferably arranged in front of the long-axis scanner component. The short-axis relay optical unit preferably comprises a 4f telescope with a cylindrical optical unit. The short-axis relay optical unit can, for example, be designed in a known manner using two correspondingly aligned aspherical lenses or optical units, which are also referred to herein as relay lenses. In particular, it can be a short-axis 4f relay optical unit.

In particular, it is possible for the short-axis relay optical unit to be arranged in the beam path behind the short-axis beam-shaping optical unit. The short-axis relay optical unit allows the short-axis far field to be controlled after beam shaping by the short-axis beam-shaping optical unit.

It is also possible for the short-axis focusing optical unit to be arranged in the beam path behind the short-axis relay optical unit. This allows the short-axis focusing optical unit to focus the output laser beam from the short-axis far-field region of the short-axis relay optical unit directly onto the workpiece in the working region.

It is also possible and preferred that the short-axis focusing optical unit is arranged in the beam path behind the long-axis scanner component. This allows the short-axis focusing optical unit to focus the output laser beam directly onto the workpiece in the working field. In particular, the distance of the short-axis focusing optical unit from the working region is thus less than the distance of the long-axis scanner component from the working region; for example, the distance of the short-axis focusing optical unit from the working region may be half or less of the distance of the long-axis scanner component from the working region. The extension of the aperture of the short-axis focusing optical unit preferably corresponds to at least half the length of the long-axis working field in the working region.

It is also possible and preferred that the short-axis scanner component is arranged in the beam path in front of the long-axis scanner component. This means that long-axis beam shaping can already take place in or before the corresponding short-axis far-field region.

It is also possible for the long-axis focusing optical unit to be arranged in the beam path behind the long-axis scanner component. Alternatively, the long-axis focusing optical unit can be arranged in the beam path in front of the long-axis scanner component.

In other words, the long-axis scanner component can advantageously be used as a post (objective) scanner component with respect to the long-axis spatial direction, even if the long-axis scanner component is arranged in front of the short-axis focusing optical unit.

It is also possible for the optical arrangement to also have a long-axis beam-shaping optical unit for beam shaping of the beam path along the long axis. The long-axis beam-shaping optical unit can, like a possible additional short-axis beam-shaping optical unit, contain or provide, for example, multiplexing, mapping, a superimposed scanning movement and/or further short-axis beam-shaping functionalities or long-axis beam-shaping functionalities. A plurality of input beams can also be provided. In this case, the long-axis beam-shaping optical unit could align the resulting partial beams with one another.

The long-axis beam-shaping optical unit can be arranged in the beam path in front of the long-axis scanner component. This means that long-axis beam shaping can already take place in a long-axis far-field region. In addition, the long-axis beam-shaping optical unit and any additional short-axis beam-shaping optical unit can be combined as a common beam-shaping optical unit. This allows beam shaping with a preferred direction that differs from the long-axis spatial direction and the short-axis spatial direction.

Otherwise, it is possible for the long-axis scanner component to be arranged in the beam path of the short-axis relay optical unit. In other words, scanning in the long-axis spatial direction can take place in the same region of the beam path to the relay in the short-axis spatial direction. In other words, the scanning in the long-axis spatial direction and the imaging or relay in the short-axis spatial direction take place substantially in the same region of the beam path. The same can apply to the long-axis focusing optical unit and/or long-axis beam-shaping optical unit.

It is also possible for the long-axis focusing optical unit and/or the short-axis focusing optical unit to be configured for telecentric focusing of the beam path. Owing to a telecentric concept, the setting angle of the output beam or out beams does not change in terms of the corresponding spatial direction across the working field of the working region. This also avoids or at least limits distortion.

Furthermore, it is also possible for the short-axis focusing optical unit to be a linear optical unit, and in particular for a length of the linear optical unit along the long axis to exceed a focal length of the short-axis focusing by at least a factor of 2, preferably of 4 or 8, and/or for the usable long-axis working field to exceed the short-axis working field by at least a factor of 2, preferably of 4 or 8. Compared to optical units with a rotationally symmetrical effect in the short-axis direction, strong focusing is possible with an extended working field in the long-axis direction.

It is also possible for the (short-axis) linear optical unit to be designed as a refractive optical unit, reflective optical unit, diffractive optical unit, geometric-phase optical unit or a combination of the aforesaid. Advantageously, refractive optical units can be designed as on-axis systems, but often require dispersion compensation and can be limiting in terms of performance and thermal and non-linear propagation effects. Reflective optical units can provide a higher numerical aperture and better performance and are typically achromatic. Disadvantages are the higher sensitivity to adjustment compared to refractive systems and increased requirements for dimensional accuracy, often coupled with increased complexity due to an off-axis design.

Advantageously, focusing takes place in the short-axis and/or long-axis spatial direction with largely negligible image field curvature on the workpiece side. These concepts, which are to be implemented separately in particular for the spatial directions, do not require z-tracking caused by an image field curvature in the scan field if the working region, in particular a working field, is flat and oriented perpendicular in the spatial direction. The image field curvature can also be reduced by combining focusing in front of the long-axis scanner component with a component (field flattener) arranged after the long-axis scanner component, and dynamic z-tracking can be avoided. In contrast to a telecentric concept, an f-theta concept allows an enlarged scan field compared to the free aperture of the optical unit due to an increasing placement angle towards the edge and has a disappearing image field curvature.

In addition or alongside the previously described adjustment of the scanning speed or machining speed on the workpiece, it is also possible for the advancement speed v_{R} of the workpiece to be varied in order to provide compensation for the relative movement, resulting from the advancement of the workpiece in the advancement direction, between the workpiece and the optical arrangement. Incidentally, this can be done at a substantially constant machining speed.

A scan can also be used to vary the long-axis scanning speed. For example, this is in order to be able to machine during the acceleration times of a possible galvo scanner or to be able to machine despite the position-dependent speed on the workpiece resulting from the constant angular speed of a polygon scanner.

A combination of short-axis and long-axis scanner components to form the effective fluence profiles and a short-axis functionality that goes beyond pure compensation are also possible.

It is also possible to provide a (fast) switch in the laser machining system for switching on/off and/or switching the input beams to different output beams.

In the following description and the figures, the same reference signs are used in each case for identical or corresponding features.

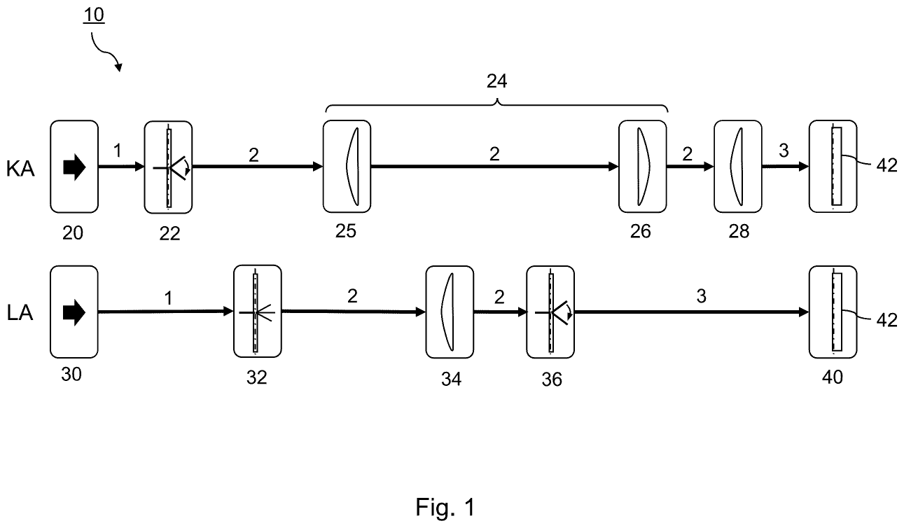

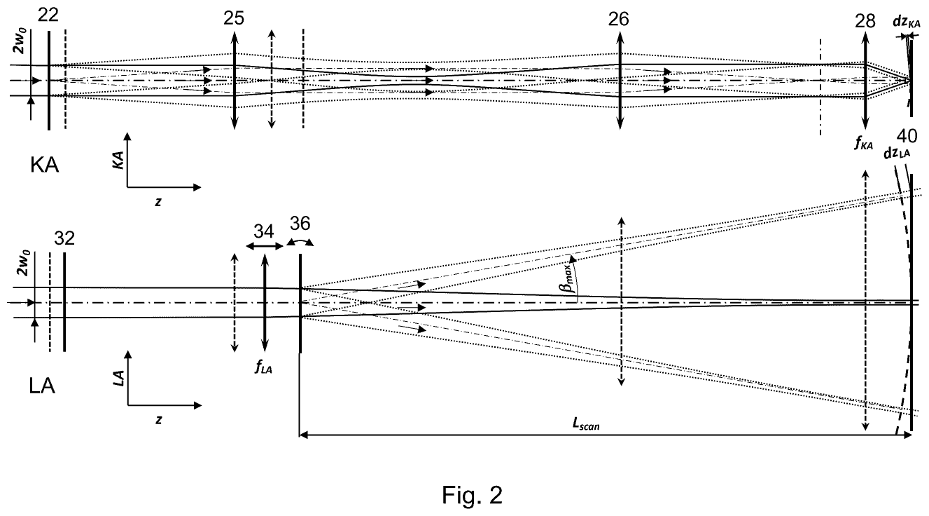

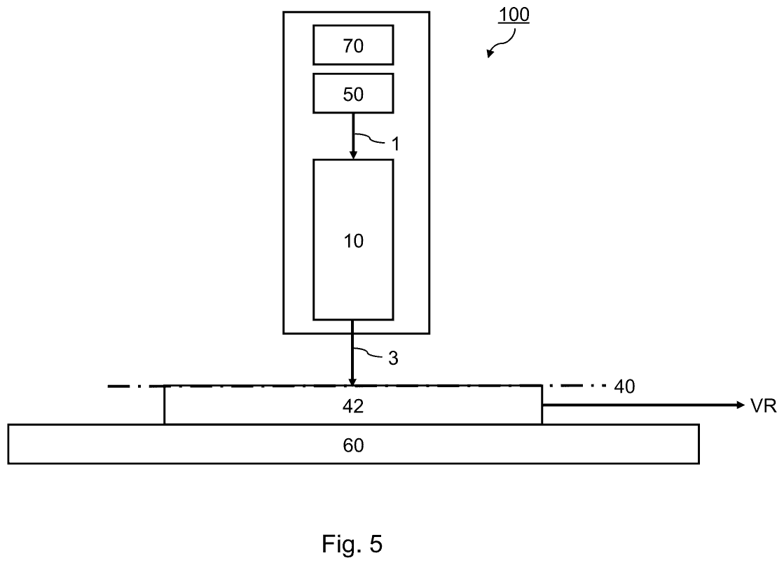

FIG. 1 shows a first exemplary embodiment of an optical arrangement 10 for a laser machining system 100 (see FIG. 5) for converting an input laser beam 1 into an output laser beam 3 extending along a long axis LA in a working region 40 or on a workpiece 42. The beam path 2 of the input laser beam 1 within the optical arrangement 10 propagates in a propagation direction z (see beam path in FIG. 2 for a telecentric case with respect to the short axis KA, in which the propagation direction z coincides with the optical axis of the optical arrangement 10) and in the working region 40 has an elliptical beam cross-section extending linearly along the long axis LA.

In addition to the linear extent along the long axis LA in the working region 40, the generated output laser beam 3 on the workpiece 42 also has an extent along a short axis KA running orthogonally with respect to the long axis LA. An aspect ratio of the short axis KA to the long axis LA can be 1:10, for example.

For a better understanding, FIG. 1 shows the optical manipulation of the beam path 2 between the input laser beam 1 and the output laser beam 3 with effect for the short axis KA and the long axis LA separately and in parallel. Furthermore, a distinction can be made within the beam path 2 in the direction of propagation between far-field regions and near-field regions related to the working region 40. A corresponding far-field region is located close to the input laser beam 1 or at the short-axis input 20 for the short axis KA and the long-axis input 30 for the long axis LA, i.e. away from the working region 40 and the workpiece 42 which is positioned there and which is to be machined by the output laser beam 3, and in particular within the optical arrangement 10. The near-field region is located in the working region 40 in which the workpiece 42 is located, and in particular coincides therewith.

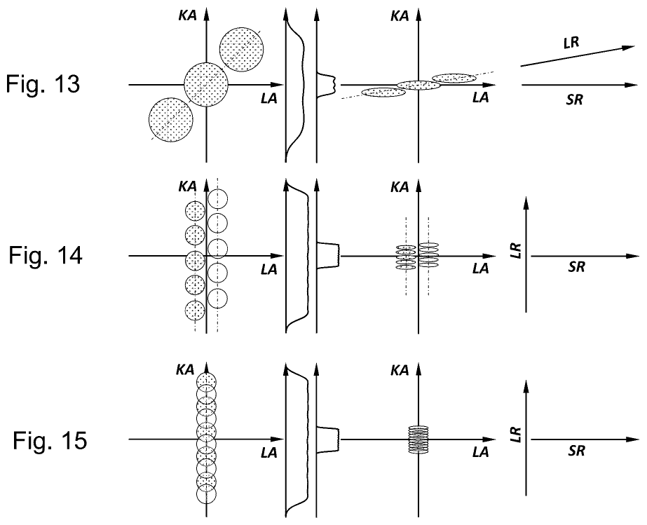

To generate the output laser beam 3, the optical arrangement 10 of FIG. 1 has a short-axis scanner component 22 for scanning the beam path 2 after entry through the input 20 with a short-axis scan direction component along the short axis KA. The angle-deflecting short-axis scanner component 22 dynamically influences the short-axis position of the output laser beam 3 in the working region 40. The beam path 2 or output laser beam 3 in the working region 40 can be deflected in the present case in the corresponding short-axis far-field region and optionally additionally shaped by a short-axis beam-shaping optical unit by changing the angular distribution of the beam path 2 there, which then affects the spatial distribution of the output laser beam 3 in the working region 40. For example, an additional short-axis beam-shaping optical unit can be used for this purpose, e.g. a diffractive element that generates a short-axis multi-spot profile, as is shown in more detail below with reference to FIGS. 13 to 24. It is also possible to alternatively/additionally influence the spatial distribution in the far-field region and thus influence the angular distribution in the working region 40, e.g. in the form of an interference-modulated profile using multi-beam interference. With respect to the long axis LA, a long-axis beam-shaping optical unit 32 follows in the beam path 2 for beam shaping or long-axis shaping of the beam path 2 along the long axis LA, in particular including static, flexible and/or dynamic beam guidance. For example, dynamic beam shaping may include a deflection superimposed on the deflection imposed by the long-axis scanner component 22. This can also be used to generate a long-axis multi-spot profile, in particular a short-axis and long-axis multi-spot profile, as shown in more detail later in FIGS. 13 to 24.

With respect to the short axis KA, an optional short-axis relay optical unit 24, which in the beam path within the optical arrangement 10 images the corresponding short-axis far-field region 2 in which the short-axis scanner component 22 is arranged, follows in the beam path 2 into the short-axis far-field region in front of the short-axis focusing optical unit 28. The relay lens 25 first performs short-axis intermediate focusing and then the relay lens 26 performs short-axis re-collimation. A short-axis 4f relay optical unit is shown here, but it can also be designed as a short-axis 2f relay optical unit with only one relay lens 26. This enables high resolution in the short-axis direction by allowing the short-axis relay optical unit 24 to control the short-axis far-field region between the relay lens 26 and the short-axis focusing optical unit 28, and in particular with a larger usable angular range. The relay optical unit 24 supports this high-resolution control even in the case of long focal-length long-axis focusing and a large long-axis extension of the working region 40, and allows the long-axis scanner component 36 to be arranged between the short-axis scanner component 22 and the especially short focal-length short-axis focusing optical unit 28. In the same region of the beam path 2 with respect to the long axis LA in the optical arrangement 10, there are a long-axis focusing optical unit 34 for long-axis focusing and a scanner component 36 for scanning the beam path 2 along the long axis LA between the two relay lenses 25, 26.

Finally, a short-axis focusing optical unit 28 is provided in the beam path 2 behind the aforementioned optical units with respect to the short axis KA in the optical arrangement 10 and focuses the output laser beam 3 along the short axis KA onto the working region 40 with the workpiece 42.

FIG. 2 shows the beam path 2 expanded with respect to the short axis KA and the long axis LA. The indicated scanning of the long-axis scanner component 36 can be performed up to an angle of β max. Furthermore, a telecentric post-scanner short-axis focusing takes place, i.e. short-axis focusing optical unit 28 in the beam path 2 behind the long-axis scanner component 36 and the short-axis scanner component 22, with a focal length fKA. The long-axis focusing is again a pre-scanner long-axis focusing with the long-axis focusing optical unit 34 in front of the long-axis scanner component 36 with the focal length fLA. The long-axis image field curvature at the distance Lscan from the long-axis scanner component 36 to the working region 40 can also be seen.

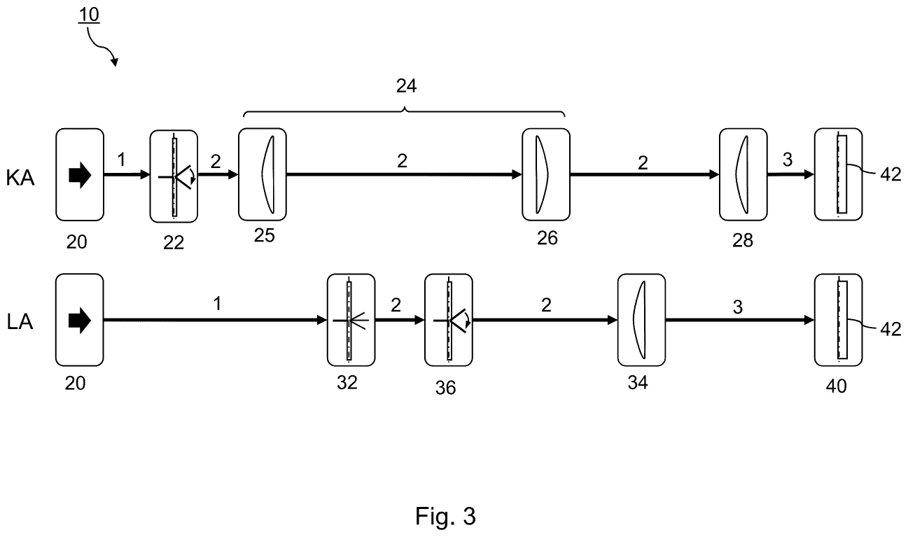

The exemplary embodiment of FIG. 3 shows a modification of the optical arrangement 10 of FIG. 1, in which both short-axis and long-axis focusing are implemented according to the post-scanner concept, i.e. the long-axis focusing optical unit 34 and the short-axis focusing optical unit 28 are arranged in the beam path 2 behind the long-axis scanner component 36 and the short-axis scanner component 22. This concept allows advantageous approaches in both directions with reduced image field curvature, such as by means of an f-theta optical unit, and in particular also a telecentric approach with further reduced variation of the angle of the output beams in the machining region. With such a concept, for example, the short-axis re-collimation by the relay lens 26 and the long-axis focusing optical unit 34 can also be combined, thus reducing the number of components with a large required aperture.

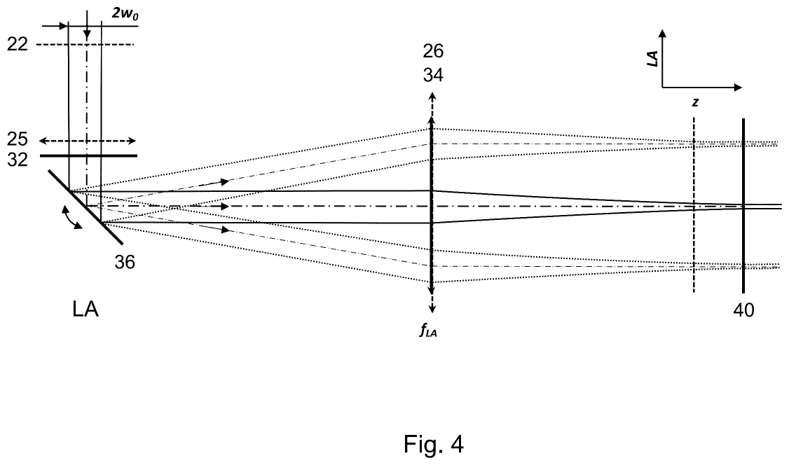

FIG. 4 shows an associated beam path 2 of the optical arrangement 10 of FIG. 3 with respect to the long axis LA. The telecentric long-axis focusing (fLA) downstream of the long-axis scanner component 36 can be seen here. This provides disappearing long-axis image field curvature and an equal long-axis angle of incidence on the workpiece 42 via the long-axis working field. The long-axis scanner component 36 and the short-axis scanner component 22 are implemented here as individual angle-deflecting, reflective scanner components, e.g. as galvo scanner components, rotating polygon mirror, etc.

The short-axis scanning by the short-axis scanner component 22 upstream of the long-axis scanner component 36 takes place in or near the short-axis far-field region. The optical components acting on the short axis KA and the short-axis far-field regions are symbolized in the long-axis beam path 2 by broken lines (see FIG. 2). The short-axis beam shaping or beam deflection takes place in a further short-axis far-field plane in front of the long-axis scanner component 36. A short-axis 4f relay image is generated, and the re-collimating relay lens 26 coincides with the long-axis focusing optical unit 34. Short-axis focusing is telecentric with a short focal length of the short axis fKA compared to the focal length of the long axis fLA.

FIG. 5 schematically shows a laser machining system 100 for machining the workpiece 42 in the working region 40 by means of the linear output laser beam 3 of the optical arrangement 10 in the laser machining system 100. The laser machining system 100 has a laser radiation source 50, in particular an ultrashort pulse laser radiation source, which provides the input laser beam 1 on the optical arrangement 10, which is converted into the output laser beam 3 and is aligned with the workpiece 42 by means of the optical arrangement 10.

Furthermore, the laser machining system 100 has an advancement device 60, for example in the form of a conveyor belt, which advances the workpiece 42, which may for example be in the form of a workpiece strip, in an advancement direction VR relative to the optical arrangement 10 and thus to the output laser beam 3. In order to compensate for a relative movement, resulting from the advancement of the workpiece 42, between the workpiece 42 and the optical arrangement 10, a control device 70 of the laser machining system 100 is also configured to coordinate the scanning of the beam path with the short-axis scanner component 22 in the short-axis scan direction component relative to the advancement.

The fact that the long-axis scanner component 36 and the short-axis scanner component 22 are scanner components that can function independently of one another, but can be synchronized via the control device 70, ensures a high degree of flexibility and quality of the laser machining of the workpiece 42 during advancement.

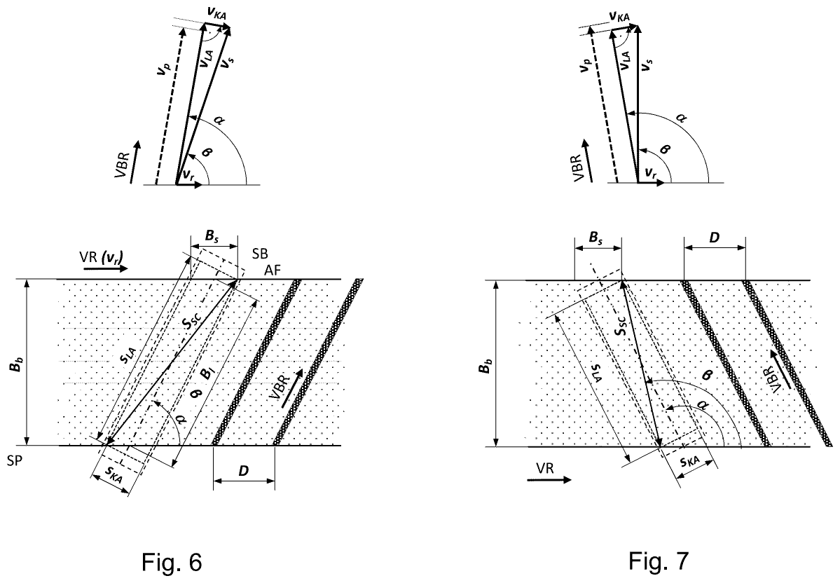

Exemplary embodiments of laser machining during advancement of the workpiece 42 are shown in FIGS. 6 and 7. FIG. 6 shows laser machining in the form of ablation over a machining width B_{b} at an advancement speed v_{R} in the advancement direction VR within a machining or scanning time tₛ in a single pass on a continuous line in an (arrangement-related) scan direction (along the scanning section S_{SC}), which here runs at an angle α to the preferred machining direction VBR along the workpiece 42, at a first angle α (0°<α<180°) with respect to the advancement direction VR by means of a beam cross-section or beam profile SP with a long-axis preferred machining direction and scanning region SB. This results in a workpiece-related machining lengthₗ=B_{b}/sin(α). To compensate for the advancement Bₛ=v_{R}·tₛ, an additional short-axis scanning movement of the short-axis scanner component 22 with a scanning region S_{KA}=Bₛ·sin(α) adjusts the scanning direction and scanning speed v_{S}. For machining over the full machining width B_{b} or machining length Bₗ, a long-axis scanning region S_{LA}=Bl+Bₛ·cos(α)=B_{b}/sin(α)+Bₛ·cos(α) is used.

As can be seen from FIGS. 6 and 7, the same machining width B_{b} can be covered for α>90° with a smaller long-axis working field (AF). For α>90°, the same effective scanning speed or process speed vₚ can be achieved with a lower scanning speed v_{LA}.

In order to limit the short-axis scan width and also the offset of successively scanned machining lines, the long-axis scanning speed v_{LA} is adjusted relative to the advancement speed v_{R}: v_{LA}=v_{R}·[B_{b}/(Bₛ·sin(α))+cos(α)]=B_{b}/(tₛ·sin(α))+v_{R}·cos(α).

As the machining intensity depends on the scanning speed without further adjustments, the parameters v_{R}, B_{b}, Bₛ and α must be selected appropriately and other process parameters (e.g. repetition frequency, long-axis profile extension, etc.) must be adjusted to these.

For a α≠90°, α>90° is preferred in order to reduce the required long-axis scanning speed and working field (AB) size compared to α<90°. A mirrored orientation of the machining geometry on the workpiece with respect to the advancement direction can be achieved by reversing the direction of the long-axis scanning movement. A parameter selection that results in an effective scan direction with scanning speed v_{S} orthogonal to the advancement direction VR (first angle α>90°, shown second angle β=90° ) is advantageous with regard to ensuring the z-position, so the z-position can only be ensured in a short range overall and in the advancement direction VR. The latter is particularly advantageous if the workpiece is guided on a deflection roller in the machining region.

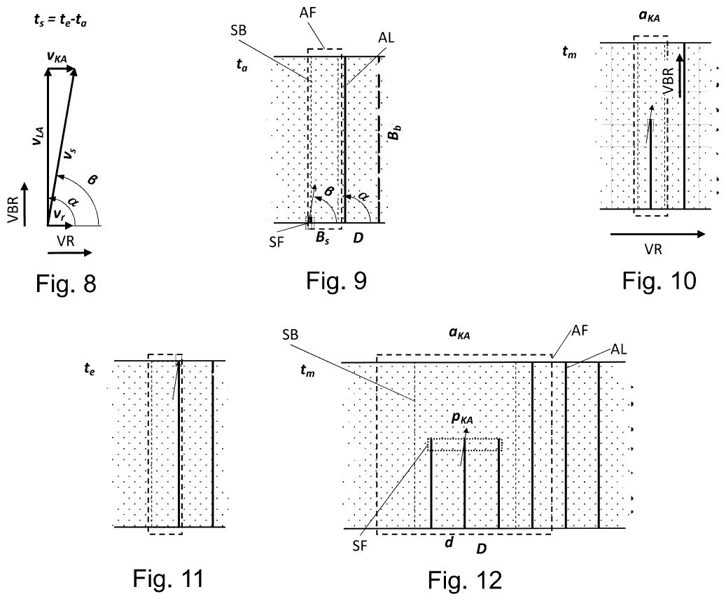

FIGS. 8 to 12 show schematic outlines of an exemplary embodiment of pulsed laser machining with the laser machining system 100 of FIG. 5 with α>90°. FIG. 8 shows the different speeds with their directions for machining, and FIGS. 9 to 12 show the laser machining at the start of machining or scanning at tₐ, in the middle of machining at tₘ and at the end of machining at tₑ, wherein FIG. 12 shows a variant with the ablation of several lines at tₘ, the distance between which significantly exceeds the line width. In the present case, the long-axis scanning speed v_{LA} corresponds to the process speed vₚ, the advancement speed v_{R} corresponds to the short-axis scanning speed v_{KA} and the machining width B_{b} corresponds to the long-axis scan length S_{LA}. The desired movement of the output laser beam 3 in the long-axis direction with the speed v_{LA} on the workpiece moving relative to the arrangement with the speed v_{R} in the short-axis direction is achieved by a scanning movement of the output laser beam 3 to the arrangement in the scan direction SR with the scanning speed v_{S}.

Suitable laser machining parameters (e.g. wavelength, fluence, pulse duration, etc.) are selected for ablation. The ablation depth is then controlled via the cumulative energy density at the location, e.g. the number of laser pulses acting at the location during one pass. In particular, the effective profile length, repetition frequency and scanning speed v_{S} are adjusted accordingly. If the effective scan direction and the advancement direction are orthogonal, then the following applies in each case for the scanning region and the working field: s_{KA}=Bₛ and s_{LA}=B_{b}=Bₗ. A working field corresponding to the scan field plus the beam shape extension in a direction is required as a minimum.

As FIG. 12 shows, the laser machining system 100 is also particularly suitable in conjunction with beam profiles of a large short-axis extension p_{KA}, e.g. for ablating several lines with distances significantly exceeding the line width. Such an application requires a large short-axis working field extension a_{KA}=p_{KA}+s_{KA} compared to the extension of a single unshaped partial beam profile.

The schematic representations in each of FIGS. 13 to 23 below show a multi-spot distribution with non-astigmatic focusing on the left, with the profiles arranged on a line. To the right of the center in the representation, it is assumed that the astigmatic focusing compresses the profile in the short-axis direction, in this example to one fifth. The resulting line direction LR of the beam cross-section or beam profile SP in the astigmatic system is symbolized on the right next to the scan direction SR. To the left of the center, fluence profiles integrated in the SR scan direction and thus effective during advancement are illustrated without and with astigmatic focusing. A coherent effective fluence profile can also be achieved with spatially separated partial beam profiles by rotating the line direction LR.

As FIG. 13 shows, the astigmatic system leads not only to the compression of the partial profiles but also to a change in the line direction LR if this does not coincide with the short-axis or long-axis direction. In addition, the rotation results in a beam profile SP which extends in the long-axis direction, without this having a positive effect on the effective fluence integrated during advancement.

The examples of FIGS. 13 to 19 are without relative movement between the workpiece 42 and the optical arrangement 10 (the scanning direction coincides with the preferred machining direction or effective scan direction, as is typical in the case of dicing, for example). During relative movement (see FIGS. 19-21), the effective scan direction is typically selected to match the long-axis direction. Furthermore, it is then advantageous to select the preferred direction of the generated line of the laser beam to be parallel or perpendicular to the long-axis direction so that no distortion or angular change occurs. To machine a narrow line during advancement with a profile as in FIG. 13, the effective scan direction can be selected in the long-axis direction or in the line direction. In the second case, however, it is not possible to achieve as narrow a line as with an alignment of the machining line in the long-axis direction (with a direction different from the long-axis direction). Using only telecentric design, rotation of the line direction during propagation and thus reduced z-position tolerance can be avoided.

Alternatively, as FIG. 14 shows, effectively coherent intensity profiles with separated partial profiles can also be achieved by a plurality of beam profiles SP aligned in the short-axis direction and offset in the long-axis and short-axis directions without the influence of the astigmatic system on the line direction LR, and also with reduced extension in the long-axis direction, with increased edge steepness.

As FIG. 15 shows, the long-axis extension can be further reduced by overlapping, preferably by avoiding intensity-modulating coherence effects, and an intensity profile of increased edge steepness can be realized that is actually and not just effectively coherent.

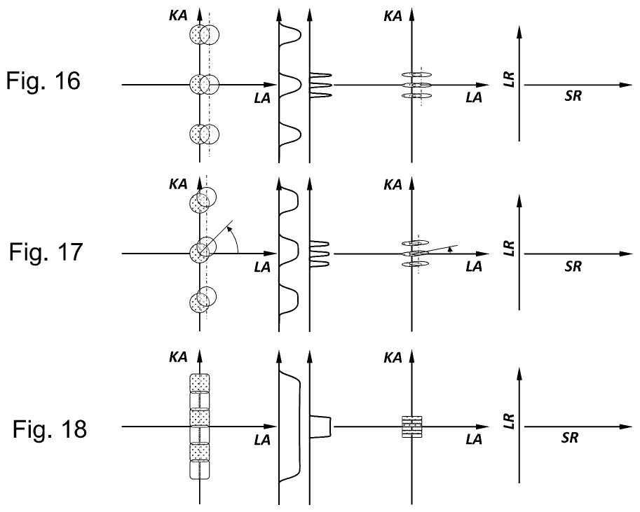

As FIG. 16 shows, beam shaping can be performed simultaneously in both the short-axis direction and long-axis direction with a direction component and at the same time in a directionally flexible manner by preferably arranging it in an overlapping (corresponding) short-axis-long-axis far-field region or short-axis-long-axis near-field region.

In the example in FIG. 17, two overlapping multi-spot profiles are realized in the machining zone by means of polarization splitting. By varying the angle of the splitting direction, the width of the effective beam profile SP acting during advancement in the long-axis direction is achieved while maintaining the edge steepness. The splitting can be realized by a beam-splitting component that causes an angular offset for mutually perpendicular polarized partial beams and is preferably arranged rotatably in a short-axis-long-axis far-field region. Alternatively, a component rotatably arranged in an overlapping short-axis-long-axis near-field region can be used, which causes a spatial offset between partial beams polarized perpendicular to each other.

Beam shaping of partial spots of a multi-spot profile in both spatial directions, here combined with an intensity-modulation-reducing polarization superposition (superposition of partial spots of mutually perpendicular polarization states, separated wavelength ranges and/or temporally offset), can also be realized by arranging the shaping preferably in a long-axis-short-axis far-field region.

In the examples of FIGS. 16 to 18, the multi-spot profiles have a preferred machining direction which corresponds to the short-axis orientation with respect to the optical arrangement 10 and is oriented towards the effective scan direction. This preferred machining direction remains substantially the same even upon rotation of the polarization splitting.

A preferred direction of machining or preferred machining direction on the workpiece 42 is often desired. FIGS. 19 to 24 show, by way of example, machining in the form of a machining line that is as narrow as possible and is continued during scanning using multi-spot profiles.

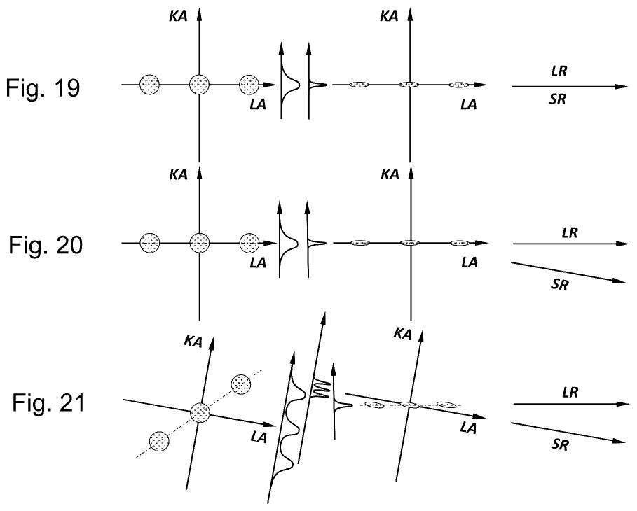

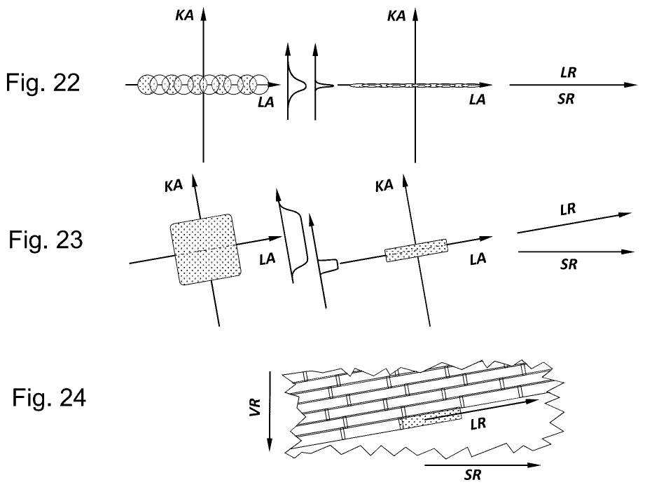

Typically, the long-axis direction is selected along the machining line. The preferred machining direction of the multi-spot line is influenced by the astigmatic focusing (either reduced (FIGS. 14-18) or, preferably, increased (FIGS. 19-22)). A distance in the advancement direction VR can be used to reduce disruptive effects such as heat accumulation and shielding. Without a relative movement between the optical arrangement and the workpiece that deviates from the long-axis direction, scanning is preferably performed in the long-axis direction (see FIGS. 19 and 22). During relative movement with a direction component that deviates from the long-axis direction, the multi-spot profile, the long-axis direction and the machining line are also preferably oriented in parallel and the relative movement is compensated for by an adjusted scan direction SR (see FIGS. 20, 23 and 24). A variation in the relative movement speed, e.g. by changing the advancement speed v_{R} and/or long-axis scanning speed v_{LA}, can be compensated for by the scan angle, for example, while maintaining the parallel orientation and the scanning speed, i.e. by adjusting the short-axis scanning speed.

If, on the other hand, scanning is restricted to the long-axis direction, it is necessary to compensate for the relative movement by means of a scan direction SR that differs from the line and to orient the multi-spot profile at an angle to the long-axis direction, as shown in FIG. 21. As explained in connection with FIG. 13, the overall result is an increased requirement for the tolerances to be adhered to and, in addition to an increased machining width with reduced edge steepness, reduced flexibility in compensating for varying advancement speeds. Configuring the optical arrangement 10 with beam shaping to form a preferred machining direction which differs from the long-axis or short-axis direction, here exemplified as a line with the direction LR, thus represents a possible solution. Preferably, however, the preferred machining directions are oriented in the short-axis direction and/or long-axis direction.

FIGS. 23 and 24 are an example of full-area machining. The machining geometry on the workpiece 42 does not have a preferred machining direction, so the long-axis direction can be freely selected. It is therefore advisable to select this direction in a line direction so that the scan direction SR in the optical arrangement 19 is oriented orthogonally with respect to the advancement direction VR. This allows machining to take place in a region which is minimized in the advancement direction within the laser machining system 100.

In order to increase the effect per scan with minimized long-axis profile length and process-adjusted fluence or to achieve the appropriate effective fluence distribution even with a small overlap of successive pulses and/or scans, customized beam profiles can also be used to advantage.

A coherent multi-spot line with reduced intensity modulation in the long-axis direction is shown by way of example (see FIGS. 15 and 18).

Furthermore, a flat-top beam profile can be used for full-area machining with a process-adjusted fluence distribution in the case of minimized pulse overlap, i.e. substantially during single-pulse machining. In this case, the preferred machining direction does not result directly from the desired machining geometry but indirectly: The scan direction is selected to be perpendicular to the advancement direction in order to minimize the system-related extension of the machining region. This results in a long-axis orientation that is adjusted to the beam shape, the advancement speed and other parameters, and a preferred machining direction that is coupled thereto.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser machining system for machining a workpiece by using an output laser beam, the laser machining system comprising:
a laser radiation source for generating an input laser beam;
an optical arrangement for converting the input laser beam into an output laser beam for machining the workpiece, wherein the output laser beam propagates in a propagation direction and has a beam cross-section in a working region that extends along a long axis of the optical arrangement, the optical arrangement comprising:
a long-axis focusing optical unit for focusing a beam path within the optical arrangement between the input laser beam and the output laser beam along the long axis,
a long-axis scanner for scanning the beam path with at least one long-axis scan direction component along the long axis,
a short-axis focusing optical unit for focusing the beam path along a short axis, and
a short-axis scanner for scanning the beam path with at least one short-axis scan direction component along the short axis;
an advancement device for advancing the workpiece relative to the optical arrangement in an advancement direction; and
a control device configured to synchronize the scanning of the beam path along the at least one long-axis scan direction component with the scanning of the beam path along the at least one short-axis scan direction component.

2. The laser machining system according to claim 1, wherein the synchronizing by the control device is performed so as to compensate for a relative movement, resulting from the advancing the workpiece in the advancement direction between the workpiece and the optical arrangement by the scanning the beam path with the short-axis scanner.

3. The laser machining system according to claim 1, wherein the long-axis scanner and the short-axis scanner function independently of each other.

4. The laser machining system according to claim 1, wherein the long-axis scanner is configured to scan the beam path in a preferred machining direction parallel to the long axis in such a way that there is a first angle α>0° between a long-axis scan direction and the advancement direction.

5. The laser machining system according to claim 4, wherein the long-axis scanner is configured at least for an average long-axis scanning speed v_{LA}=B_{b}/(tₛ·sin(α))+v_{R}·cos(α), and/or the short-axis scanner is configured at least for an average short-axis scanning speed v_{KA} =vᵣ·sin(α), wherein B_{b} is a machining width on the workpiece perpendicular to the advancement direction, tₛ is a machining time for a machining length Bₗ=B_{b}/sin(α), and v_{R} is an advancement speed in the advancement direction.

6. The laser machining system according to claim 5, wherein the long-axis scanner is configured for a long-axis scan field length s_{LA}≥B_{b}/sin(α) +Bₛ·cos(α), and/or the short-axis scanner is configured for a short-axis scan field width s_{KA}≥Bₛ·sin(α), wherein Bₛ is a length swept over during scanning.

7. The laser machining system according to claim 1, wherein the optical arrangement is configured so that the beam cross-section is formed by a multi-spot profile.

8. The laser machining system according to claim 7, wherein the multi-spot profile has spots distributed along the short axis and the long axis.

9. The laser machining system according to claim 7, wherein a line direction of the multi-spot profile of the beam cross-section resulting from astigmatic focusing of the optical arrangement is set at a setting angle of >0° relative to the long-axis scan direction component.

10. The laser machining system according to claim 1, wherein the control device is configured to adjust a laser power of the output laser beam to a speed of the scanning of the beam path.

11. The laser machining system according to claim 1, wherein the laser radiation source is a pulsed laser radiation source.

12. The laser machining system according to claim 11, wherein the control device is configured to adjust a pulse repetition frequency to a speed of a beam movement of the output laser beam on the workpiece and/or a speed of the scanning with the long-axis scanner.

13. The laser machining system according to claim 11, wherein the control device is configured for position-synchronized pulse triggering along the long axis.

14. The laser machining system according to claim 11, wherein the control device is configured for position-adjusted selection of laser machining parameters along the long axis.

15. The laser machining system according to claim 1, wherein the long-axis scanner carries a measuring beam path of an optical sensor system.
